(19) United States
(12) Patent Application Publication
(10) Pub. No.: US 2005/0231506 A1
(43) Pub. Date: Oct. 20, 2005

(54) Triangle identification buffer

(75) Inventors: Robert Simpson, Bristol (GB); Zahid Hussain, Berkshire (GB)

Correspondence Address: SEED INTELLECTUAL PROPERTY LAW GROUP PLLC, 701 FIFTH AVE, SUITE 6300, SEATTLE, WA, 98104-7092, US

(73) Assignee: STMicroelectronics Limited, Bristol (GB)

(21) Appl. No.: 10/445,295

(22) Filed: May 22, 2003

Related U.S. Application Data
(63) Continuation of application No. 10/279,091, filed on Oct. 22, 2002, now abandoned.

(30) Foreign Application Priority Data
Oct. 25, 2001 (EP) 01309059.2

(51) Int. Cl. G06T 15/40; G09G 5/02; G09G 5/36

(52) U.S. Cl. 345/422; 345/605; 345/549; 345/694

(57) ABSTRACT

A method of rendering a plurality of triangles into a color buffer defined by a plurality of pixel locations, utilizing a triangle identification buffer and a depth buffer. A relatively unique identifier is assigned to each of the triangles to be rendered. Before color and texture mapping, each triangle is depth compared on a per pixel basis. If a pixel of a current triangle is in front of any existing pixel at that point, the current triangles identifier is over-written into a triangle identification buffer. Color texture data is only retrieved for each triangle that appears in the identification buffer once all triangles have been compared.

### BACKGROUND OF THE INVENTION

1. Field of the Invention

The present disclosure relates generally to graphical manipulation of objects defined in three-dimensional space, and more particularly but not exclusively, to the rendering of such objects into a color buffer for subsequent display on a two-dimensional screen such as a computer monitor.

One embodiment of the invention has been developed primarily for use in graphics chips where speed and throughput of rendered polygons is paramount, and will be described hereinafter with reference to this application. However, it will be appreciated that the invention is not limited to use in this field.

2. Description of the Related Art

The market for “3D” accelerator video cards for PCs and other computing platforms has grown drastically in recent years. With this growth has come an increasing desire for faster accelerator chips incorporating an increasing number of features such as realistic lighting models and higher onscreen polygon counts at higher resolutions.

A typical 3D accelerator includes a rasterizing section that takes mathematical representations of the polygons (usually triangles) in three-dimensional space and renders them down to a two dimensional representation suitable for display on a computer monitor or the like. The steps in this procedure are relatively well known in the art, and include a color rendering stage where colors from a texture map associated with each polygon are mapped to individual pixels in the two dimensional buffer. Due to memory bandwidth issues, it is desirable to reduce the amount of textures that are imported for mapping onto each polygon.

To ensure that polygons are drawn correctly on the screen, each pixel of each polygon as it is considered is depth compared with any pixel already at a corresponding pixel location in the color buffer. This is usually done with reference to a depth buffer. In one such arrangement, the depth buffer is the same size as the color buffer, and is used to maintain depth data in the form of a depth value for each pixel that has been written to the color buffer. When a new pixel is being considered, its depth value is compared with the depth value associated with any pixel that has already been written to the color buffer at the new pixel's location. In the event that the new pixel is behind the old, then it is discarded because it will be obscured. Conversely, if the new pixel is in front of the old, the new pixel's depth value replaces that of the old pixel in the depth-buffer, and color data is retrieved from associated texture memory and written over the old pixel's color data in the color buffer.

Whilst it provides technically useful results, the use of a depth buffer in this fashion often results in large amounts of texture data unnecessarily being retrieved and written to the color buffer. This is because a particular pixel location in the color buffer may be written over several times as new is triangles are found to overlay existing triangles at those locations.

### BRIEF SUMMARY OF THE INVENTION

In accordance with a first aspect of the invention, there is provided a method of rendering a plurality of triangles into a color buffer defined by a plurality of pixel locations, utilizing a triangle identification buffer and a depth buffer, the method including:
(a) assigning a relatively unique identifier to each of the triangles to be rendered;
(b) generating triangle pixels based on a first one of the triangles, each of the triangle pixels having associated with it an (x,y) position and a depth value;
(c) writing the depth value associated with each of the pixels to pixel locations in the depth buffer, the pixel locations corresponding with the respective (x,y) positions generated in (b);
(d) writing the identifier associated with the triangle to the pixel locations in the buffer corresponding with the respective (x,y) positions generated in (b); and
(e) for each remaining triangle to be rendered:
   (i) generating triangle pixels, each of the triangle pixels having associated with it an (x,y) position and a depth value;
   (ii) comparing the depth value of at least some of the triangle pixels generated in (i) with the depth values stored at respective corresponding pixel locations in the depth buffer, thereby to determine for each pixel location whether the triangle whose identifier is already in the triangle identification buffer is in front of or behind the triangle being compared; and
   (iii) in the event that the triangle whose identifier is already in the triangle identification buffer is behind the triangle being compared at a given pixel location, writing the identifier of the triangle being compared into the identification buffer at that pixel location;
(f) mapping color data into the color buffer on the basis of the contents of the triangle buffer once at least a plurality of the triangles has been depth compared.

In one embodiment, (f) includes:
(i) selecting an identifier from the identifier buffer;
(ii) retrieving from the triangle buffer the triangle associated with the selected identifier;
(iii) rasterizing the triangle, computing color only, such that, for each pixel coordinate being considered, if the identification buffer contains the identifier of the triangle being rasterized, writing the color value of the triangle at that coordinate to the color buffer; and
(iv) repeating (i) to (iii) until the triangles associated with all identifiers in the identifier buffer have been rasterized.

In an embodiment, in the event a triangle being rasterized in (f) has a texture associated with it, (f) further includes forwarding information to the texture cache to enable prefetching of the texture to commence.

In an embodiment, the depth buffer and the triangle identification buffer are combined, such that, at each address defining a pixel location in the combined buffer, there is space for a depth value and a triangle identifier value.

In one form, the depth buffer and triangle buffer are combined with the color buffer, such that, at each address defining a pixel location in the combined buffer, there is space for the depth value, the triangle identifier value and color values.

In one embodiment, generating triangle pixels includes scan converting the triangles for which the pixels are to be generated.

The color data are based on textures stored in an associated texture memory according to one embodiment.

### BRIEF DESCRIPTION OF THE SEVERAL VIEWS OF THE DRAWINGS

Embodiments of the present invention will now be described, by way of example only, with reference to the accompanying drawings, in which:

FIG. 1A is a schematic diagram showing a graphics accelerator card architecture for generating a texture mapped two-dimensional representation of a plurality of polygons represented in three-dimensional space, in accordance with the method of an embodiment of the invention;

FIG. 1B is a schematic diagram showing the features of one of the VPUs shown in FIG. 1A;

FIG. 2 is a diagram showing setup information for a triangle to be rendered from three-dimensional space to a two-dimensional buffer;

FIG. 3 is a state diagram showing the steps involved in drawing a triangle;

FIG. 4 is a flowchart showing the steps involved in marking which triangles are active, and therefore visible, for the purposes of mapping color pixels thereto, in accordance with an embodiment of the invention;

FIG. 5 is a flowchart showing the steps involved in mapping color to the active pixels calculated in FIG. 4;

FIG. 6 is a block diagram of a general-purpose personal computer (“PC”) incorporating graphics acceleration hardware in accordance with the invention;

FIG. 7 is a representation of the contents of a buffer once identifiers of a first triangle have been written into it;

FIG. 8 is a representation of the buffer of FIG. 7 after identifiers of a second triangle have been written into it; and

FIG. 9 is a flowchart showing the steps involved in processing triangles after setup, in accordance with an embodiment of the invention.

### DETAILED DESCRIPTION OF THE INVENTION

Embodiments of a triangle identification buffer are described herein. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

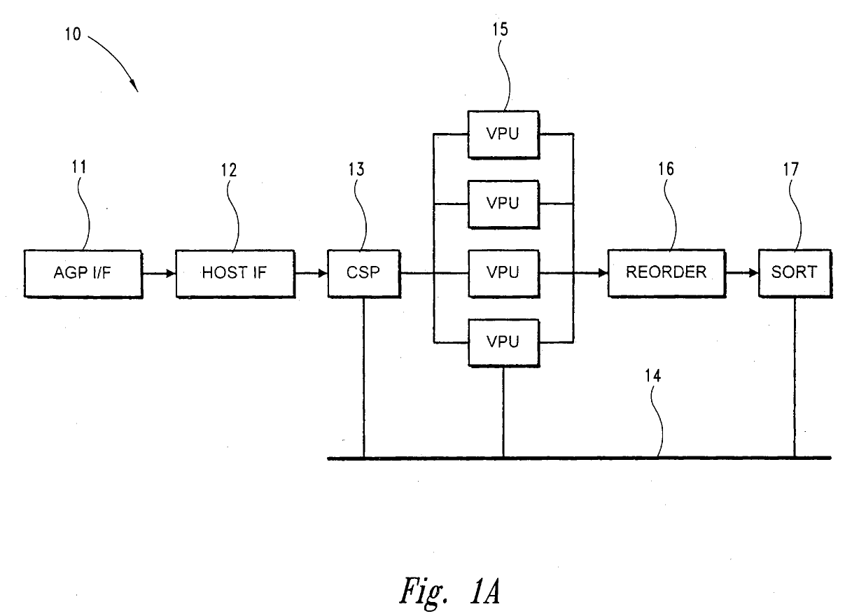

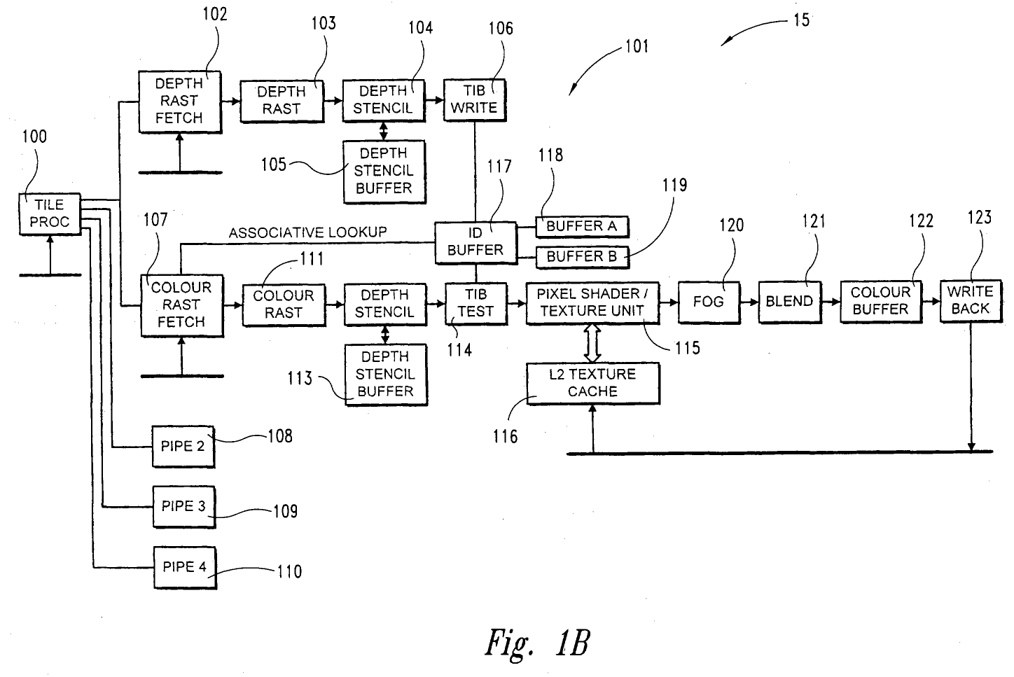

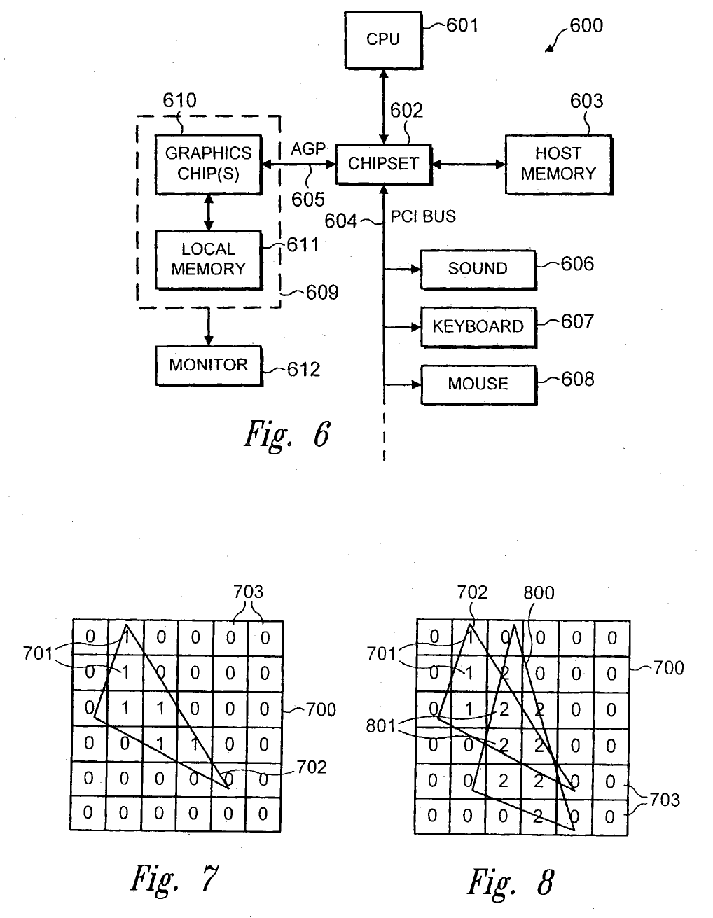

FIG. 1A shows an architecture for generating a two dimensional output for display on, say, a computer monitor, such as that shown in FIG. 6, based on representations of one or more polygons in three dimensional space. In most cases, including an embodiment described herein, the polygons will take the form of triangles. This is because triangles are always planar and convex, and therefore mathematically easier to deal with than other polygons.

In FIG. 1A, there is shown a graphics accelerator card 10 that includes an Accelerated Graphics Port (AGP) interface 11 connected to a host interface 12. The host interface is in turn connected to a Command Stream Processor (CSP) 13. The CSP has a variety of functions. For example, it interprets the graphics command stream, differentiating between the vertex information and the state information. It is responsible for fetching data from the host. It can also reformat vertex data into a form more suitable for the Vertex Processing Units (VPUs) described below, packetizing the data where necessary.

The CSP 13 is in communication with the video card system memory (not shown) via an on-board bus 14, and is also connected to a set of programmable Vertex Processing units (VPUs) 15 which are themselves connected to the bus 14 to enable access to the video card and system memory.

The CSP 13 controls the VPU processors 15 on the basis of instructions from the host computer (as described later in relation to FIG. 6). The processed polygon data from the VPU processors 15 is then reordered and sorted for display by reordering and sorting circuitry 16 and 17 respectively.

One of the VPU processors 15 will now be described in more detail with reference to FIG. 1B. The multiple VPU processors 15 are substantially identical. The advantages and disadvantages of pipelined processing are well understood. However, the highly repetitive nature of calculations used in video acceleration programming, along with the relatively small number of branches and jumps (all of which behave predictably) makes pipelining particularly well suited to this type of processing.

With reference to FIG. 1B, this shows the VPU 15 as having four pipelines 101, 108, 109 and 110. In practice, more or less pipelines can be used. The first pipeline 101 is shown in more detail. The other pipelines 108, 109 and 110 will have generally the same structure. The input to each of the pipelines is provided by a tile processor 100 which fetches the tile data from memory and feeds the rasterizing units. The tile processor also generates the triangle identifiers and maintains the triangle buffers.

The tile processor provides an output to a depth raster fetch unit 102 which is arranged to request a triangle for processing. This depth information is provided to a depth raster unit 103 which is arranged to rasterize only the depth value for a given triangle.

The output of the depth raster unit 103 is input to a depth stencil unit 104 which is connected to a depth stencil buffer 105. The depth stencil unit and buffer are arranged to check whether the depth and stencil test passes and updates the depth and stencil buffers accordingly.

The output of the depth stencil unit is input to triangulation information buffer TIB write unit 106. This unit 106 is arranged for those pixels in the triangle which survive the depth and stencil test, to write the corresponding identifiers to the identification buffer 117. The ID buffer is connected to a first buffer 118 and a second buffer 119.

The output of the tile processor 100 is also input to a color raster fetch unit 107 which is arranged to fetch a triangle from the triangle buffer with an identifier that is valid in the identification buffer. For this reason there is a associative look up connection to the identification buffer 117.

The output of the color raster fetch unit 107 is provided to a color raster unit 111 which is arranged to rasterise only the color value (diffuse and specular) for each surviving triangle. The output of the color raster unit 111 is input to a depth stencil unit 112 which is connected to a depth stencil buffer 113. The depth stencil unit 112 and depth stencil buffer 113 provide the same function as the depth stencil unit 104 and depth stencil buffer 105 described previously.

The output of the depth stencil unit 112 is connected to a triangulation information buffer test unit 114 which is arranged so that if the color rasterized pixel passes the identifier test (ie the triangle identifier—that is the identifier in the triangle identifier buffer at that pixel position), then the pixel is passed on to a pixel shader/texture unit 115 which is connected to a texture cache 116. The pixel shader/texture unit 115 is connected to a fog unit 120 which computes the fog value based on the the distance from the observer and applies to the texture mapped pixel. The output of the fog unit 120 is input to a blending unit 121 which provides a blending operation. The output of the blending unit 120 is input to a color buffer 122 the output of which is connected to a write back unit 123. The output of the write back unit 123 is fed back to the texture cache 116.

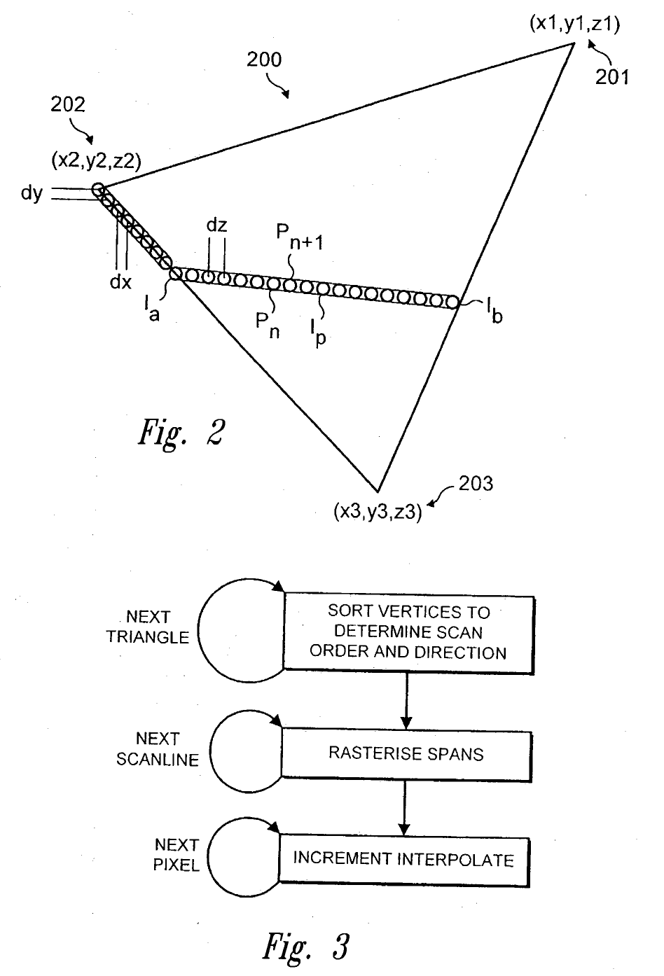

Initially, triangles are set up for scan conversion. This is shown in more detail in FIG. 2, in which is shown an exemplary triangle 200 ready for scan conversion. The triangle 200 is defined by set of three tuplets 201, 202 and 203 that specify coordinates, color and texture information at each vertex. These tuplets are:
(X₁, Y₁, Z₁, R₁, G₁, B₁, A₁, U₁¹ V₁¹, . . . , Uₙ¹,Vₙ¹) (1)
(X₂, Y₂, Z₂, R₂, G₂, B₂, A₂, U₁² V₁², . . . , Uₙ²,Vₙ²) (2)
(X₃, Y₃, Z₃, R₃, G₃, B₃, A₃, U₁³V₁³, . . . , Uₙ³,Vₙ³) (3)

The values represented by the variables will be well understood by those skilled in the art of three-dimensional graphics. The tuplet information represents values of vertices of the triangle. By definition, this means that they lie in the plane of the triangle, so the triangle can be rasterized by interpolating the values at those vertices. Also, whilst only one set of color components (RGB) is defined in the above tuplets, it is common for two sets to be defined, one for diffuse lighting and the other for specular lighting.

As is shown in FIG. 3, there are three states involved in rasterizing triangles:
1. For each triangle, the gradient of the variables must be calculated;
2. The start values for each span must be calculated; and
3. For each pixel, it must be ascertained whether the pixel must be plotted and, if so, the pixel's value must be determined.

In prior art methods, every pixel that passes the depth buffer test is plotted. This means that, unless the triangles are depth sorted and plotted from front to back, triangles that will not ultimately be visible will still be rasterized. Moreover, such triangles will also be texture mapped, which places an undesirable burden on memory bandwidth.

In accordance with one embodiment, this “overdraw” problem is ameliorated by making a depth assessment of each pixel prior to full rendering. In this way, only those triangles that will actually be visible in the final image will actually go through the relatively bandwidth-hungry rendering stages. It will be appreciated by those skilled in the art that this has the added advantage of speeding up subsequent anti-aliasing procedures.

In an embodiment, this result is achieved by allocating a relatively unique identifier to each triangle to be rendered. By “relatively unique”, it is meant that each triangle is uniquely identified with respect to all other triangles that define the three dimensional components of a particular tile or frame being rendered. For example, a triangle that appears in consecutive frames or adjacent tiles may well be allocated a different identifier in each of those frames.

Referring to FIGS. 1 and 3, each triangle is rasterized to translate the mathematically-defined triangle into a pixel-defined triangle. Rasterizing is well known to those skilled in the art, and so will not be described in detail. Examples of suitable rasterizing techniques are described in “Computer Graphics: Principles and Practice” by James Foley et al.

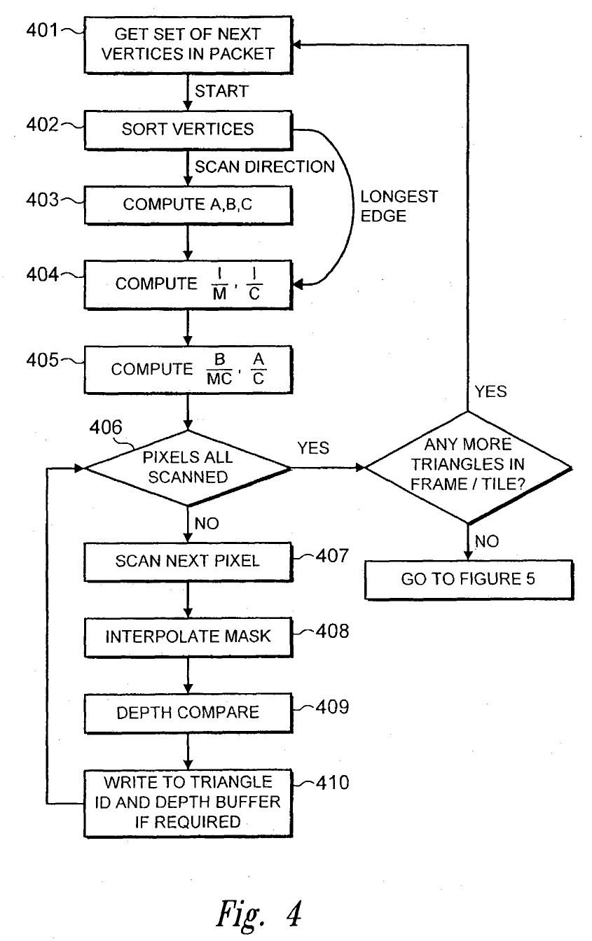

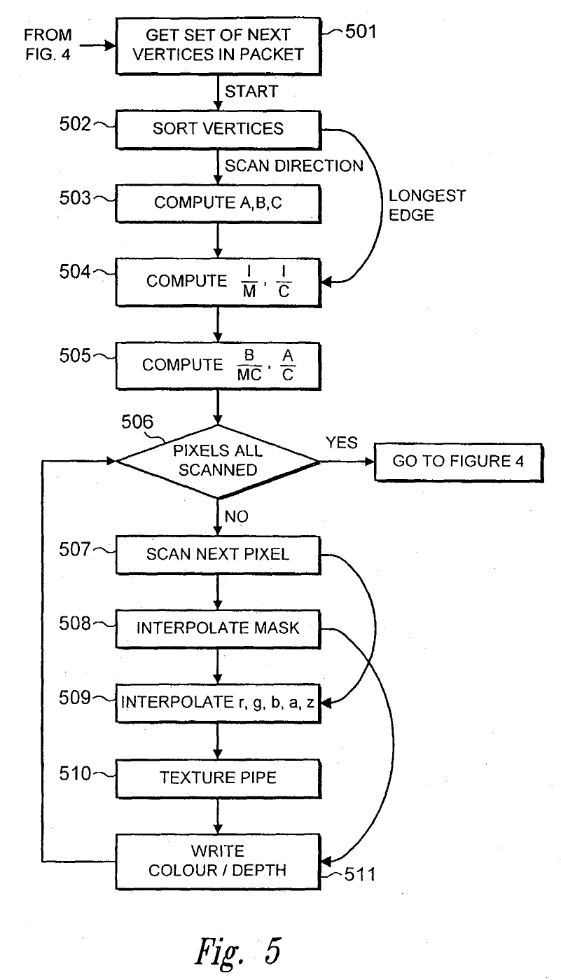

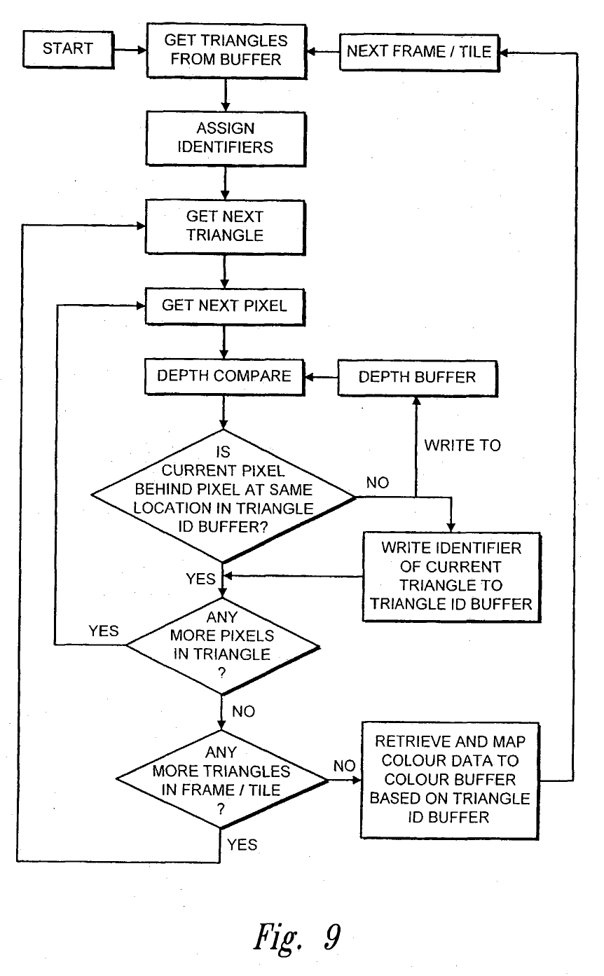

FIG. 4 represents the steps involved in finding out which triangles will be visible and therefore need to be rendered, whilst FIG. 5 represents the steps involved in plotting color/texture pixels to the color buffer for the visible pixels determined in FIG. 4. FIG. 9 summarizes these steps in a more simplified format.

Prior to the steps of FIG. 4 being taken for a given frame or title, each pixel location in the depth-buffer is set to a “far distance” value, such that any pixel subsequently depth-compared with one of the initial values will always be considered “on top” of the initial value. It will be noted that steps 402 to 408 of FIG. 4 correspond with steps 502 to 508 to FIG. 5, and in some embodiments can be performed in the same hardware.

In step 409, a comparison is made between the depth value of the current pixel and that representing the corresponding pixel location in the depth-buffer. If the pixel already at that position in the color buffer has a depth greater than that of the value at the corresponding position in the depth buffer, then the identifier for the triangle being compared is written into the triangle identification buffer and the depth overwritten into that position in the depth buffer.

For the first triangle being scanned, the contents of the identification buffer and the depth-buffer are shown in FIG. 7. It will be noted that all values in the identification buffer 700 are zero other than those pixel locations 701. associated with the first triangle 702. Naturally, in alternative embodiments, any other default value can be used to represent a “no triangle” state.

Each of the pixel locations corresponding to the pixels generated in relation to the first triangle 702 contains the value of the unique identifier originally allocated to the triangle (in this case, the digit “1”). Each corresponding pixel location in the depth-buffer has stored within it a z-value associated with that pixel.

For subsequent triangles being scanned, the depth value of the current pixel being scanned is compared to the depth value stored in the pixel location in the depth-buffer corresponding to that of the triangle. It will be appreciated that, if the corresponding pixel location has not yet had triangle data written to it, the pixel presently being considered will by definition be visible in the event that no further triangles have pixels at that location. The unique identifier associated with the current triangle will then be written directly to the corresponding pixel location to replace the default value.

The contents of the triangle identifier buffer after a second triangle 800 has been written to it is shown in FIG. 8, along with the first triangle 702 from FIG. 7. It will be noted that the second triangle 800 is in front of the first triangle 702 where they overlap, and so the unique identifier 801 of the second triangle (the digit “2”) has been written over the first triangle identifiers in the pixel locations corresponding with the overlap area. Similarly, in the depth buffer the depth values corresponding to the overlapping second triangle have also overwritten the depth values of the first triangle. Those portions of the second triangle 800 that are not overlapping the first triangle 700 are also written to the depth and triangle identifier buffers.

Steps 401 to 410 are repeated until all triangles for the frame or tile being rendered have been processed. In the present example, only the two triangles need to be rendered, so the resultant triangle identifier buffer state is that shown in FIG. 8.

At this stage, the final rendering procedure shown in the flowchart 500 of FIG. 5 is implemented. The initial step 501 is to search the ID buffer to locate an active triangle. A triangle can be considered active if one or more pixels associated with it are in the depth-buffer. As each active triangle is found, a corresponding set of vertices is retrieved from memory.

Further steps are then undertaken in accordance with steps 502 to 505, which are known to those skilled in the art and therefore not described in detail. Once step 507 is reached, however, things proceed differently from the procedure of FIG. 4. The interpolate mask is still generated, in accordance with step 508. However, r, g, b, a and z are then interpolated in step 509 for each of the live pixels of present triangle. The resultant values are then passed to the texture pipe 510, in which texture mapping takes place. This involves mapping a texture stored in memory to the triangle on a pixel-by-pixel basis. The procedure is relatively well known in the art, and so will not be described here in further detail.

It will be noted from FIG. 5 that there is some feed-forwarding of data, in particular from the output of step 507 (to step 509) and step 508 (to step 511).

Once all pixels have been scanned and texture/color mapped, other processing, such as anti-aliasing, can be applied in accordance with known procedures. The resultant frame, representing a two-dimensional view of the three dimensional representations, is output to a display device such as a computer monitor.

FIG. 9 shows a summarized version of the steps described in relation to the other Figures. The steps themselves are self-explanatory in view of the previous detailed description and so will not be described in further detail herein.

Other architectures and approaches can be used in conjunction with the invention. For example, it will be appreciated that the invention is amenable to use with different triangle plotting schemes, such as strips or fans. Also, the method can be applied to entire frames, or sub-frames in the form of tiles, depending upon the desired implementation. It will be appreciated that additional steps may be required in some cases to, for example, convert polygons (generated during tiling or due to framing considerations) into triangles, but this is well known within the art and so has not been described further herein.

In one form, the invention is embodied in a specialist graphics processor on a graphics accelerator card. Such cards are used as components in personal and business computers, such as an IBM compatible PC 600 shown in FIG. 6. In the embodiment illustrated, the PC includes, amongst other things, a general-purpose processor in the form of a Pentium III processor 601, manufactured by Intel Corporation. Via a chipset 602, the processor 601 communicates with host memory 603, a PCI bus 604 and an Advanced Graphics Port (AGP) bus 605. The PCI bus 604 allows the chipset 602 to interface with various peripheral components, such as a soundcard 606, a keyboard 607 and a mouse 608. The AGP bus 605 is used to communicate with a graphics accelerator card 609, which includes, amongst other things, a graphics chip 610 and local memory 611. The graphics card outputs graphics signals to a computer monitor 612. One embodiment of the present invention is incorporated in the hardware, software and firmware of the graphics card 609.

It will be seen from the detailed description that an embodiment of the present invention provides a method of rendering polygons from a three-dimensional to a two-dimensional space, whilst reducing overall texture bandwidth requirements.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention and can be made without deviating from the spirit and scope of the invention.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method of rendering a plurality of triangles into a color buffer defined by a plurality of pixel locations, utilizing a triangle identification buffer and a depth buffer, the method including:
(a) assigning a relatively unique identifier to each of the triangles to be rendered;
(b) generating triangle pixels based on a first one of the triangles, each of the triangle pixels having associated with it an (x,y) position and a depth value;
(c) writing the depth value associated with each of the pixels to pixel locations in the depth buffer, the pixel locations corresponding with the respective (x,y) positions generated in (b);
(d) writing the identifier associated with the triangle to the pixel locations in the triangle identification buffer corresponding with the respective (x,y) positions generated in (b);
(e) for each remaining triangle to be rendered:
(i) generating triangle pixels, each of the triangle pixels having associated with it an (x,y) position and a depth value;
(ii) comparing the depth value of at least some of the triangle pixels generated in (e)(i) with the depth values stored at respective corresponding pixel locations in the depth buffer, thereby to determine for each pixel location whether the triangle whose identifier is already in the triangle identification buffer is in front of or behind the triangle being compared; and
(iii) in the event that the triangle whose identifier is already in the triangle identification buffer is behind the triangle being compared at a given pixel location, writing the identifier of the triangle being compared into the triangle identification buffer at that pixel location; and
(f) mapping color data into the color buffer on the basis of contents of the triangle identification buffer once at least a plurality of the triangles has been depth compared.

2. A method according to claim 1 wherein (f) includes:
(i) selecting an identifier from the triangle identification buffer;
(ii) retrieving from the triangle identification buffer a triangle associated with the selected identifier;
(iii) rasterizing the triangle, computing color only, such that, for each pixel coordinate being considered, if the triangle identification buffer contains the identifier of the triangle being rasterized, writing the color value of the triangle at that coordinate to the color buffer; and
(iv) repeating (f)(i) to (f)(iii) until the triangles associated with all identifiers in the triangle identification buffer have been rasterized.

3. A method according to claim 2 wherein, in the event a triangle being rasterized in (f) has a texture associated with it, (f) further includes forwarding information to a texture cache to enable prefetching of the texture to commence.

4. A method according to claim 1 wherein the depth buffer and the triangle identification buffer are combined, such that, at each address defining a pixel location in the combined buffer, there is space for a depth value and a triangle identifier value.

5. A method according to claim 4 wherein the depth buffer and triangle identification buffer are combined with the color buffer, such that, at each address defining a pixel location in the combined buffer, there is space for the depth value, the triangle identifier value, and color values.

6. A method according to claim 1 wherein generating triangle pixels includes scan converting the triangles for which the pixels are to be generated.

7. A method according to claim 1 wherein the color data are based on textures stored in an associated texture memory.

8. A method of rendering a plurality of polygons into a color buffer defined by a plurality of pixel locations, the method comprising:
(a) assigning an identifier to each of the polygons to be rendered;
(b) generating pixels based on a first one of the polygons, each of the pixels having associated with it a position and a depth value;
(c) writing the depth value associated with each of the pixels to pixel locations, the pixel locations corresponding to the respective positions generated in (b);
(d) writing the identifier associated with the polygon to the pixel locations corresponding to the respective positions generated in (b);
(e) for each remaining polygon to be rendered:
(i) generating pixels, each of the pixels having associated with it a position and a depth value;
(ii) comparing the depth value of at least some of the pixels generated in (e)(i) with the depth values stored at respective corresponding pixel locations, to determine for each pixel location whether the polygon whose identifier is already written is behind the polygon to be rendered; and
(iii) if the polygon whose identifier is already written is behind the polygon to be rendered at a given pixel location, writing the identifier of the polygon to be rendered into that pixel location; and
(f) mapping color data into the color buffer once at least a plurality of the polygons has been depth compared.

9. The method of claim 8 wherein the polygons comprise triangles.

10. The method of claim 8 wherein (f) includes:
(i) selecting an identifier;
(ii) retrieving a polygon associated with the selected identifier;
(iii) rasterizing the polygon, computing color only in a manner that for each pixel coordinate being considered, if the identifier of the triangle being rasterized is previously written, writing the computed color of the polygon at that coordinate to the color buffer; and
(iv) repeating (f)(i) to (f)(iii) until the polygons associated with all identifiers have been rasterized.

11. The method of claim 10 wherein if a polygon being rasterized in (f) has a texture associated with it, (f) further includes forwarding information to a texture cache to allow prefetching of the texture to commence.

12. A system, comprising:
a color buffer having a plurality of pixel locations;
an identification buffer;
a depth buffer; and
a machine-readable medium having instructions stored thereon, which if executed by a processor, perform the following:
(a) assign an identifier to each of the polygons to be rendered;
(b) generate pixels based on a first one of the polygons, each of the pixels having associated with it a position and a depth value;
(c) write the depth value associated with each of the pixels to pixel locations in the depth buffer, the pixel locations corresponding to the respective positions generated in (b);
(d) write the identifier associated with the polygon to the pixel locations in the identification buffer corresponding to the respective positions generated in (b);
(e) for each remaining polygon to be rendered:
(i) generate pixels, each of the pixels having associated with it a position and a depth value;
(ii) compare the depth value of at least some of the pixels generated in (e)(i) with the depth values stored at respective corresponding pixel locations in the depth buffer, to determine for each pixel location whether the polygon whose identifier is already written in the identification buffer is behind the polygon to be rendered; and
(iii) if the polygon whose identifier is already written in the identification buffer is behind the polygon to be rendered at a given pixel location, write the identifier of the polygon to be rendered into the identification buffer at that pixel location; and
(f) map color data into the color buffer once at least a plurality of the polygons has been depth compared.

13. The system of claim 12 wherein the polygons comprise triangles.

14. The system of claim 12 wherein the instructions (f) include instructions to:
(i) select an identifier from the identification buffer;
(ii) retrieve a polygon associated with the selected identifier from the identification buffer;
(iii) rasterize the polygon, compute color only in a manner that for each pixel coordinate being considered, if the identifier of the triangle being rasterized is previously written in the identification buffer, writing the computed color of the polygon at that coordinate to the color buffer; and
(iv) repeating (f)(i) to (f)(iii) until the polygons associated with all identifiers in the identification buffer have been rasterized.

15. The system of claim 14, further including a texture cache, wherein if a polygon being rasterized in (f) has a texture associated with it, the instructions (f) further include instructions to forward information to the texture cache to allow prefetching of the texture to commence.

16. The system of claim 12 wherein the depth buffer and the identification buffer are combined in a manner where for each address defining a pixel location in the combined buffer, there is space for a depth value and a identifier value.

17. The system of claim 12 wherein the depth buffer and identification buffer are combined with the color buffer in a manner where for each address defining a pixel location in the combined buffer, there is space for a depth value, an identifier value, and a color value.
